(19) United States
(12) Patent Application Publication
(10) Pub. No.: US 2015/0161171 A1
(43) Pub. Date: Jun. 11, 2015

(54) SMART CLASSIFIEDS

(71) Applicant: Suresh Thankavel, Brookfield, WI (US)

(72) Inventor: Suresh Thankavel, Brookfield, WI (US)

(21) Appl. No.: 14/564,274

(22) Filed: Dec. 9, 2014

Related U.S. Application Data
(60) Provisional application No. 61/914,070, filed on Dec. 10, 2013.

(51) Int. Cl. G06F 17/30; G06K 9/18; G06K 9/46; G06Q 30/02

(52) U.S. Cl. CPC G06F 17/30253; G06Q 30/0277; G06K 9/18; G06K 9/46

(57) ABSTRACT

A system and method for providing the text recognition application for advertisers to view the classified advertisement in the publication. The advertisement is scanned using the application in the smart device including the smart phone, the tablet, Kindle®, Nuke®, Notepad®, wearable computer or technology (optical head mounted display (OHMD)) such as wearable Google® glass, etc. The application recognizes the advertisement in the form of the text or image and displays the appropriate digital contents like the video, image, animated, static 3D or 2D object or additional digital material, which is complementary to the selected or scanned classified advertisement.

### STATEMENT OF RELATED APPLICATIONS

This patent application claims the benefit of U.S. Provisional Patent Application No. 61/914,070 having a filing date of 10 Dec. 2013.

### BACKGROUND

1. Field of the Invention

This invention discloses a system and method for text recognition within a classified advertisement for advertisers including consumer or individuals and business or companies with a virtually participative experience while viewing the classified advertisement in a publication.

2. Discussion of Prior Art

Advertisers who are interested in conveying deals and other promotional offers to the masses, use several ways to convey the message. One of them is the print media such as newspapers, magazines, pamphlets, and menu cards. Examples of such uses include real estate buys and sells, automobile sales, etc.

EP 1361524 A1 titled “Method and system for processing classified advertisements” describes a method for preparing classified advertisements for publication in a printed media by capturing the textual content of each classified advertisement expressed in natural language and automatically classifying and extracting the data units from the textual content and storing each data unit into a corresponding field of a record in an electronic database. The database is then used for determining the textual content, the layout and the position of the classified advertisement in the said printed media.

U.S. Pat. No. 8,521,737 B2 titled “Method and system for multi-tier image matching in a mixed media environment” describes a computer-implemented method for producing a mixed media document that is formed from at least two media types. The invention discloses a mixed media reality (MMR) system that uses printed media in combination with electronic media to produce mixed media documents. The computer-implemented method receives the first image of a document and identifies with one or more processors by comparing the first image to a library of images comprising at least one image that includes the culling feature and location of the culling feature of the first image based on the number of overlaps.

US 20110170788 A1 titled “Method for capturing data from mobile and scanned images of business cards” describes a method for capturing various data fields from a mobile and scanned images of business cards. The procedure involves capturing the data from the business card containing multiple fields by generating a list of text line-based alternatives (T-alternatives) for each field, computing an ASCII value for each T-alternative and computing a confidence for each T-alternative from the highest to the lowest confidence. The list of T-alternatives for each field is generated by determining the list of T-alternatives for a personal name field and a company name field. The invention also describes the method for capturing an email, an URL or a telephone number from an image of the business card having multiple fields by selecting a particular field, providing a set of keywords as input for the field followed by entering an optical character recognition (OCR) results of the image, entering a format of the field and determining any alternative keyword locations within the OCR results along with corresponding match confidences and combining the keyword locations and data locations with the keywords, which are properly aligned with the data, with no other text items in between.

### BRIEF SUMMARY OF THE INVENTION

In the present invention, a classified advertisement is scanned using the application in the smart device including any one or more smart phone, tablet, Kindle®, Nuke®, Notepad®, Google® glass or other similar wearable computer or technology (optical head mounted display (OHMD), using the inbuilt camera on the smart device. The application recognizes the advertisement and displays appropriate digital contents that are complimentary to the selected or scanned classified advertisement to provide additional information relative to the classified advertisement positioning the content on the recognized advertisement.

The user runs the application in the smart device that has an inbuilt camera. The application then uses the camera to scan the text in the classifieds. It uses the OCR (optical character recognition) technique to recognize the text. The application recognizes the key text called as identifier. The key is usually an alpha numeric text or an image. The related information is fetched in the form of digital contents such as images, photographs, video clips, 3-dimentional (3D) and 2-dimensional (2D) files or redirect to other web pages, or to open up other features of the application, runs another application or transfer to a different web page. The application recognizes the text, a word or combination of words (alpha, alpha numeric or numeric) or the image within the advertisement or tender or other printed material. The publisher may choose to differentiate the key in the printed material by various ways such as highlighting, font style differentiation, prefix or postfix with other character images. The application recognizes the text using multiple techniques including object character recognition (OCR) method, which compares the American Standard Code for Information Interchange 1 (ASCII) and the image recognition method for the match in the pre-defined set of texts in the database. If there is a match, it triggers a different event such as displaying other digital contents such as videos, 3D or images or text configured in the database. The users can install from the operating system of the device, web portal or distributed through other sources. E.g.: For smart phone having iPhone Operating System (iOS) and phones developed by Apple, the application is made available from the portal where other Apple applications are maintained for end users. In this case, the end users are smart phone users, who are interested in using the application for their respective device.

The advertiser advertises real estate availability and provides the contact number. The user, who reads the advertisement uses one of the devices, opens this innovative application and scans on the advertisement. The application has a scan mode where the camera of the device focuses on the advertisement. Users then locate the camera view of the smart device on top of the advertisement for the application to recognize the text. Depending on the need, the application can recognize the entire portion of the advertisement or a section of the advertisement.

This invention includes a computer-implemented method to enable recognition and rendering of one or more portions of advertisements in multiple languages having (a) an advertisement in alpha-numeric text, (b) a database, (c) supplementary digital content, and (d) a camera comprising the steps of:

Scanning text relating to an advertisement with a camera on a smart-device;

Recognizing the text relating to a portion of the advertisement using optical character recognition;

Comparing the text with previous entries of the database; and

Rendering supplementary digital content related to the advertisement.

The method of this invention has a database, which comprises one or more entries including key text related to an advertisement and supplementary digital content related to an advertisement. The supplementary digital content is indexed using a key identifier and stored in the database and is related to an advertisement includes images, photographs, video clips, 3-Dimentional (3D) and 2-Dimensional (2D) files, web pages and additional features within the method. The text of the advertisement includes text in one or more languages, font style and type in one or more colors, one or more dimensions and one or more image elements. One embodiment of this invention further comprises the steps of:

A user scanning the text in the advertisement using an inbuilt camera on a smart device;

A user input control for cropping the image in a defined area to recognize the text;

A processor recognizing and converting the text into a pixel format (an image) and further converting the image into text;

Comparing and matching the resulting text with the fetched data in the database;

On finding a match in the database, assigning the match as a key;

Using the key to fetch supplementary digital content in the database by calling the display function to search the data for the key wherein the display function further comprises the steps of:
Calling the database to select appropriate supplementary digital content;

Populating the database containing the supplementary digital content by various means such as triggering by external applications to insert automatically or by providing input mechanism to the users, who input the digital content along with key; and

Generating the key automatically by using random key generators and other means such as sequence key generators.

This invention further includes a system to enable recognition and rendering of one or more portions of advertisements in multiple languages having (a) an advertisement in alpha-numeric text, (b) a database, (c) supplementary digital content, and (d) a camera comprising:

A component to scan text relating to an advertisement with a camera on a smart-device;

A component to recognize the text relating to a portion of the advertisement using optical character recognition;

A component to compare the text with previous entries of the database; and

A component to render supplementary digital content related to the advertisement.

This invention further includes a computer readable medium having embodied thereon a program, the program being executable by a processor to enable recognition and rendering of one or more portions of advertisements in multiple languages having (a) an advertisement in alpha-numeric text, (b) a database, (c) supplementary digital content, and (d) a camera, the method comprising the steps of:

Scanning text relating to an advertisement with a camera on a smart-device;

Recognizing the text relating to a portion of the advertisement using optical character recognition;

Comparing the text with previous entries of the database; and

Rendering supplementary digital content related to the advertisement.

### BRIEF DESCRIPTION OF THE DRAWINGS

FIG. 1 illustrates the scanning control, user input control and a database used by the application.

FIG. 2 illustrates a sample of the classified advertisement.

FIG. 3 illustrates the application recognizing the entire portion of the advertisement.

FIG. 4 illustrates the application recognizing a section of the advertisement.

FIG. 5 illustrates the application recognizing the advertisement and displaying further images in the digital content.

FIG. 6 illustrates an overall flowchart to recognize the classified advertisement using the application.

### DETAILED DESCRIPTION OF PREFERRED EMBODIMENTS

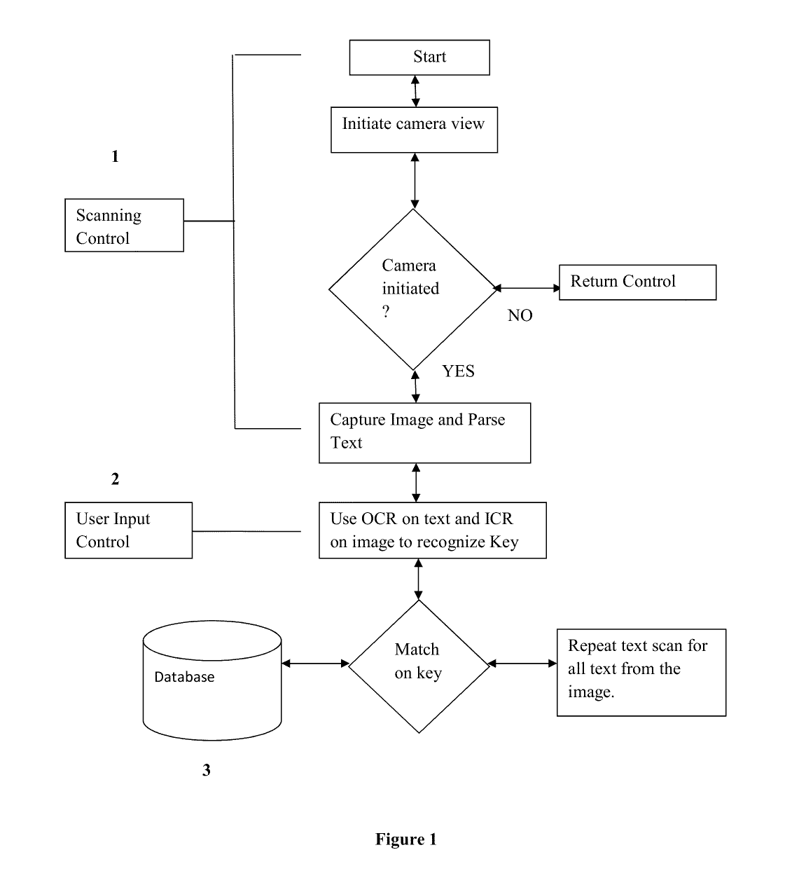

FIG. 1 illustrates the scanning control, user input control and the database used by the application. The scanning control 1 helps the application camera view to focus the text. The user has to hold the device facing the camera on the text to be scanned. The user input control 2 runs the application in the device and selects the scan mode of the application. During processing, the application recognizes the text using the optical character recognition (OCR) technique. The text is compared with the text in the database 3.

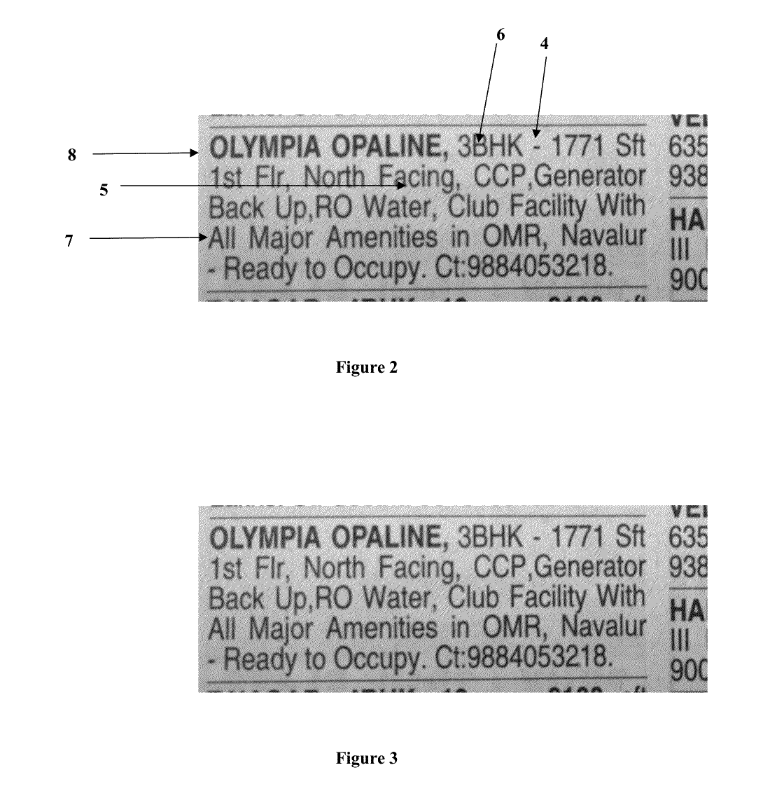

FIG. 2 illustrates the sample of classified advertisement. The classified advertisements are typically two to five lines of alpha numeric 4 displayed in a separate section called classified in news media that are distributed to commercial and residential purpose. The classified advertisements are printed in various languages and font style and type. The sentences can be in various languages 5 and printed in various fonts or scripts such as English alphabets, etc., or can be alphanumeric 6 or numeric in nature and of different color and style of fonts 7. The languages are English alphabets (from A to Z in upper case or lower case letters) and other scripts. Numeric is numbers from 0, 1, 2, 3, 4, 5, 6, 7, 8, and 9 and combinations thereof. Alpha numeric means the combination of alphabets and numbers in any order. The style of the font refers to representation of the font in different styles such as italics, etc. Different types of fonts include Arial, Times New Roman, etc. These fonts can be in bold or in normal 8. The background of the advertisements is typically white and can be in different colors. The application can recognize one or more classifieds that fits within the camera view.

FIG. 3 illustrates the application recognizing the entire portion of the advertisement. Depending on the need of the user, the application recognizes the entire portion of the advertisement.

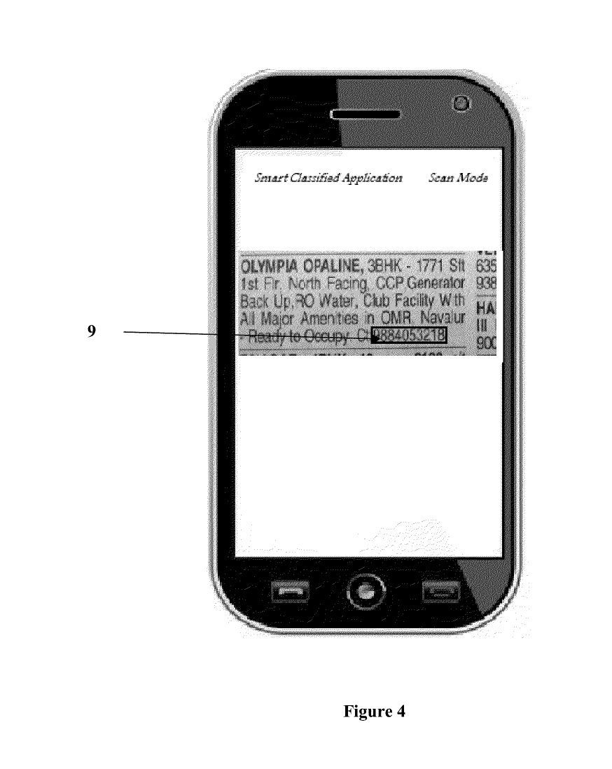

FIG. 4 illustrates the application recognizing the section of the advertisement. Depending on the need of the user, the application recognizes the section 9 of the advertisement.

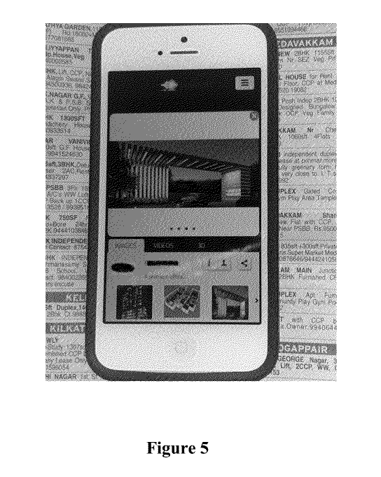

FIG. 5 illustrates the application recognizing the advertisement and displaying further images in the digital content. The application recognizes the text either in printed or handwritten format using optical character recognition (OCR) technique. The code or text recognized is matched with the code in the database. If there is a match, then the application displays the digital content of the relevant information.

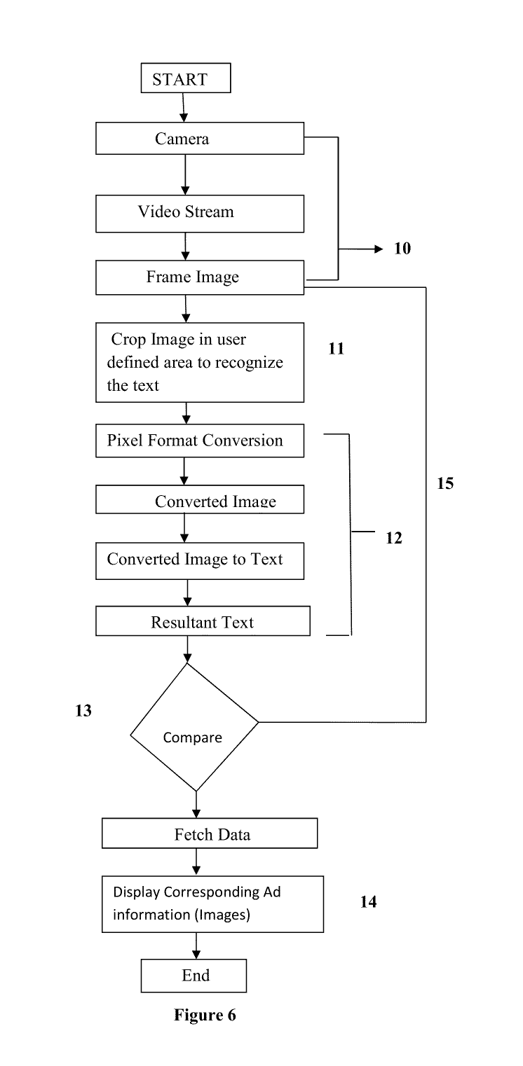

FIG. 6 illustrates an overall flowchart to recognize the classified advertisement using the application. The user scans the text in the classified advertisement using the inbuilt camera 10 in the smart device. The user input control 2 of the application crops the image in a defined area to recognize the text 11. The processor recognizes and converts the text into a pixel format and further the converted image into text 12. The resulted text is compared and matched 13 with the fetched data in the database 3. If the positive match is found, it is considered as the key. The key is then used to fetch the related digital contents in the database by calling the display function to search the data for the key and displays the digital information 14. The display function calls the database 3 to select the appropriate digital content. The database 3 contains the digital content and can be populated by various means such as triggering by external applications to insert automatically or by providing input mechanism to the users, who shall input the digital information along with key. The key could also be generated automatically by the system using random key generators or other means such as sequence key generators. The digital content includes video clips, panoramic, various image type, 2D or 3D static or animated objects, redirect to other web pages, or to open up other features of the application, run another application or transfer to the different web page. If the negative match is found, the control is sent back to scan the image again 15.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A computer-implemented method to enable recognition and render at least one portion of advertisements in multiple languages having (a) an advertisement in alpha-numeric text, (b) a database, (c) supplementary digital content, and (d) a camera comprising the steps of:
a) scanning text relating to an advertisement with a camera on a smart-device;
b) recognizing the text relating to a portion of the advertisement using optical character recognition;
c) comparing the text with previous entries of the database; and
d) rendering supplementary digital content related to the advertisement.

14. The computer-implemented method of claim 13, wherein the database comprises at least one entry including:
a) key text related to an advertisement; and
b) supplementary digital content related to an advertisement.

15. The computer-implemented method of claim 13, wherein the supplementary digital content is indexed using a key identifier and stored in the database.

16. The computer-implemented method of claim 13, wherein the supplementary digital content related to an advertisement includes images, photographs, video clips, 3-Dimentional (3D) and 2-Dimensional (2D) files, web pages, and additional features within the method.

17. The computer-implemented method of claim 13, wherein the text of the advertisement includes:
a) text in at least one language, font style, and type;
b) at least one color;
c) at least one dimension; and
d) at least one image element.

18. The computer-implemented method of claim 13, further comprising the steps of:
a) a user scanning the text in the advertisement using an inbuilt camera on a smart device;
b) a user input control for cropping the image in a defined area to recognize the text;
c) a processor recognizing and converting the text into a pixel format as an image and further converting the image into text;
d) comparing and matching the resulting text with the fetched data in the database;
e) on finding a match in the database, assigning the match as a key;
f) using the key to fetch supplementary digital content in the database by calling the display function to search the data for the key wherein the display function further comprises the steps of:
f1) calling the database to select appropriate supplementary digital content;
g) populating the database containing the supplementary digital content by various means such as triggering by external applications to insert automatically or by providing input mechanism to the users, who input the digital content along with key; and
h) generating the key automatically by using random key generators and other means such as sequence key generators.

19. A system to enable recognition and rendering of at least one portion of advertisements in multiple languages having (a) an advertisement in alpha-numeric text, (b) a database, (c) supplementary digital content, and (d) a camera comprising:
a) a component to scan text relating to an advertisement with a camera on a smart-device;
b) a component to recognize the text relating to a portion of the advertisement using optical character recognition;
c) a component to compare the text with previous entries of the database; and
d) a component to render supplementary digital content related to the advertisement.

20. The system of claim 19, wherein the database comprises at least one entry including:
a) key text related to an advertisement; and
b) supplementary digital content related to an advertisement.

21. The system of claim 19, wherein the supplementary digital content is indexed using a key identifier and stored in the database.

22. The system of claim 19, wherein the supplementary digital content related to an advertisement includes images, photographs, video clips, 3-Dimentional (3D) and 2-Dimensional (2D) files, web pages, and additional features within the method.

23. The system of claim 19, wherein the text of the advertisement includes:
a) text in at least one language, font style, and type;
b) at least one color;
c) at least one dimension; and
d) at least one image element.

24. The system of claim 19, further comprising:
a) a component to enable a user to scan the text in the advertisement using an inbuilt camera on a smart device;
b) a component enabling user input control for cropping the image in a defined area to recognize the text;
c) a processor recognizing and converting the text into a pixel format as an image and further converting the image into text;
d) a component to compare and match the resulting text with the fetched data in the database;
e) a component to assign the match as a key upon finding a match in the database;
f) a component to use the key to fetch supplementary digital content in the database by calling the display function to search the data for the key wherein the display function further calling the database to select appropriate supplementary digital content;
g) a component to populate the database containing the supplementary digital content by various means such as triggering by external applications to insert automatically or by providing input mechanism to the users, who input the digital content along with key; and
h) a component to generate the key automatically by using random key generators and other means such as sequence key generators.

25. A computer readable medium having embodied thereon a program, the program being executable by a processor to enable recognition and rendering of one or more portions of advertisements in multiple languages having (a) an advertisement in alpha-numeric text, (b) a database, (c) supplementary digital content, and (d) a camera, the method comprising the steps of:
a) scanning text relating to an advertisement with a camera on a smart-device;
b) recognizing the text relating to a portion of the advertisement using optical character recognition;
c) comparing the text with previous entries of the database; and
d) rendering supplementary digital content related to the advertisement.

26. The computer readable medium having embodied thereon a program of claim 25, wherein the database comprises at least one entry including:
a) key text related to an advertisement; and
b) supplementary digital content related to an advertisement.

27. The computer readable medium having embodied thereon a program of claim 25, wherein the supplementary digital content is indexed using a key identifier and stored in the database.

28. The computer readable medium having embodied thereon a program of claim 25, wherein supplementary digital content related to an advertisement includes images, photographs, video clips, 3-Dimentional (3D) and 2-Dimensional (2D) files, web pages, and additional features within the method.

29. The computer readable medium having embodied thereon a program of claim 25, wherein the text of the advertisement includes:
a) text in at least one language, font style, and type;
b) at least one color;
c) at least one dimension; and
d) at least one image element.

30. The computer readable medium having embodied thereon a program of claim 25, further comprising the steps of:
a) a user scanning the text in the advertisement using an inbuilt camera on a smart device;
b) a user input control for cropping the image in a defined area to recognize the text;
c) a processor recognizing and converting the text into a pixel format as an image and further converting the image into text;
d) comparing and matching the resulting text with the fetched data in the database;
e) on finding a match in the database, assigning the match as a key;
f) using the key to fetch supplementary digital content in the database by calling the display function to search the data for the key wherein the display function further comprises the steps of:
f1) calling the database to select appropriate supplementary digital content;
g) populating the database containing the supplementary digital content by various means such as triggering by external applications to insert automatically or by providing input mechanism to the users, who input the digital content along with key; and
h) generating the key automatically by using random key generators and other means such as sequence key generators.
